(19) United States
(12) Patent Application Publication
(10) Pub. No.: US 2004/0203726 A1
(43) Pub. Date: Oct. 14, 2004

(54) Testing system for cellular phone module and method thereof

(75) Inventor: Chang Chin Wei, Taipei (TW)

Correspondence Address: HAVERSTOCK & OWENS LLP, 162 NORTH WOLFE ROAD, SUNNYVALE, CA, 94086, US

(73) Assignee: Arima Communication Corp.

(21) Appl. No.: 10/397,791

(22) Filed: Mar. 25, 2003

(30) Foreign Application Priority Data
Nov. 20, 2002 (TW) 091133892

(51) Int. Cl. H04Q 7/20

(52) U.S. Cl. 455/423; 455/67.11; 455/67.14

(57) ABSTRACT

The present invention is an automatic testing system for a cellular phone module and a method thereof for automatically test a cellular phone module. The present invention includes a control computer having a graphic controlled program for providing a test request, wherein the graphic controlled program is written in Labview program, and a testing device electrically connected to the control computer and the cellular phone module for testing the cellular phone module in response to the testing request. The testing result is sent back to the control computer from the testing device right after the test is finished. Then the testing result is displayed via a graphic interface and stored in a text file and a graph file. The cellular phone module is determined to be good or not via the testing result.

### FIELD OF THE INVENTION

This invention relates to a testing system and a method thereof and more particularly to a testing system for a cellular phone module and a method thereof.

### BACKGROUND OF THE INVENTION

In the process of designing the cellular phone, it is necessary to test all the functions on the developing products to assure them meet all the related legislation. Please refer to FIG. 1, it is a schematic diagram of a cellular phone function testing system, including a test device 11, a cellular phone module 14 for testing and a power supply 15. The test device 11 has a radio-frequency output/input point 12. The radio-frequency output/input point 12 is connected to the aerial point of cellular phone module 14 via a radio-frequency cable 13. The power supply 15 provides necessary and correct voltage for the cellular phone module 14.

The test device (e.g. an Agilent wireless communication tester 8960) used in the current cellular phone industry requires engineers to manually operate them. And these test devices of the prior art can only record and display the data and the graph of the current measurement. The test results can't be recorded and displayed accumulatively. The engineers need to test the cellar phone functions in the processes of designing cellular phone and assure them meet all the related legislation of European Telecommunication Standard Institute (ETSI). The test items include TX power, phase error, frequency error, power vs time, output radio frequency spectrum (ORFS), RX sensitivity and RX level. Especially, some test items need to measure every single traffic channel and MX/TX level under different frequencies (Enhanced Global Standard for Mobile Communication 900, EGSM 900). It takes lots of effort and time for the design team to do them manually.

Because of the technical defects described above, the applicant keeps on carving unflaggingly to develop “testing system and method for cellular phone module” through wholehearted experience and research.

### SUMMARY OF THE INVENTION

It is an object of the present invention to develop the graphic control program that combines the current test device and automatically tests TX/RX functions for the cellular phone products. The test results can be displayed in GUI (Graphic User Interface) and also be stored in both text and graphic files. This will help the RD engineer to discover the potential problems of the design. And the automatic test environment definitely helps a lot on saving manpower, test time and discovering problems and greatly improves the disadvantages of prior arts. Therefore, the present invention has its value for this industry and that is the main reason why this present invention is.

It is another object of the present invention to provide a testing system for a cellular phone module, which includes a control computer having a graphic controlled program for providing a test request, wherein the graphic controlled program is written in Labview program, and a testing device electrically is connected to the control computer and the cellular phone module for testing the cellular phone module in response to the testing request.

Preferably, the system includes a power supply electrically connected to the cellular phone module for providing electricity.

Preferably, the testing device is a wireless communication tester.

Preferably, the testing device is electrically connected to the control computer via a GPIB cable.

Preferably, the testing device is electrically connected to the cellular phone module via a radio frequency cable.

Preferably, the control computer sends a test request to the testing device and then receives a testing result from the testing device, wherein the control computer further includes a graphic interface for showing the testing results, wherein the testing result is stored in a text file and a graph file.

Preferably, the text file is an EXCEL file and the graph file is a JPG file.

Preferably, the graphic interface includes a main displaying frame, a cursor function list and a graphic control list.

Preferably, the test request is one selected from a group consisting of a TX power test, a phase peak error test, a phase root mean square (phase RMS) test, a frequency error test, a power vs time test, an output radio frequency spectrum (ORFS) test, a sensitivity test and a RX level test.

Preferably, the output radio frequency spectrum (ORFS) test includes a modulating spectrum test and a switching spectrum test.

Preferably, the RX level test includes an input level sweep test and a frequency channel sweep test.

It is another object of the present invention to provide a method for testing a cellular phone module via a testing device and a control computer having a test request, including steps of: (a) sending a test request from a control computer to the testing device, (b) testing the cellular phone module in response to the test request via the testing device for obtaining a testing result, (c) sending the testing result from the testing device to the graphic controlled program, (d) displaying and saving the result via the graphic controlled program, and (e) determining the cellular phone module is good or not via the result.

Preferably, the control computer includes a graphic controlled program.

Preferably, the graphic controlled program is written in Labview program language.

Preferably, the test request is one selected from a group consisting of a TX power test, phase peak error test, a phase root mean square (phase RMS) test, a frequency error test, a power vs time test, an output radio frequency spectrum (ORFS) test, a sensitivity test and a RX level test.

Preferably, the output radio frequency spectrum (ORFS) test includes a modulation frequency spectrum test and a switching frequency test.

Preferably, the RX level test includes an input level sweep test and a channel sweep test.

Preferably, the testing device is a wireless communication tester.

Preferably, the text file is an EXCEL file and the graph file is a JPG file.

Preferably, the graph interface includes a main displaying frame, a cursor function list and a graph control list.

Preferably, the result is stored in a text file and a graph file.

### BRIEF DESCRIPTION OF THE DRAWINGS

FIG. 1 shows a schematic diagram of the testing system for a cellular phone module of prior arts.

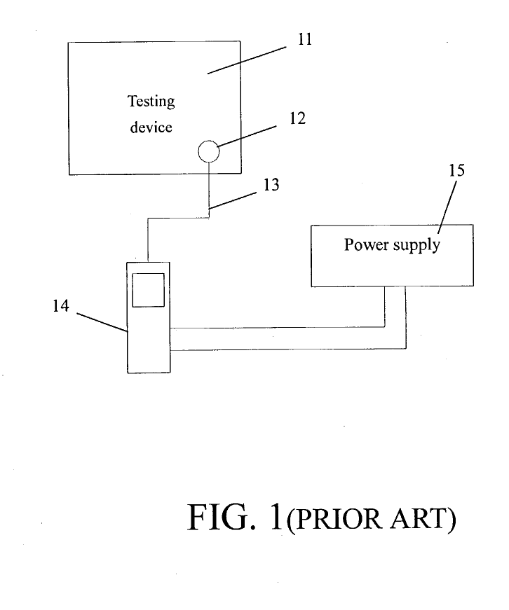

FIG. 2 shows the schematic diagrams of the testing system for a cellar phone module to a preferred embodiment of the present invention.

FIG. 3 shows the initial displaying frame of the testing system for a cellular phone module to a preferred embodiment of the present invention.

FIG. 4 shows the displaying frame of a TX power test item for the testing program to a preferred embodiment of the present invention.

FIG. 5 shows the test result of a RX level (channel sweep) test item for scanning all of the EGSM 900 frequencies.

### DETAILED DESCRIPTION OF THE PREFERRED EMBODIMENT

For improving the disadvantages of prior arts, the present invention is to develop the graphic controlled program (Labview in the present invention) that combines the current test device (An Agilent wireless communication tester 8960 in the present invention). and automatically tests TX/RX functions for the cellular phone products. So, we can assure the products to meet the related legislation. The automatic testing program tests the TX power, phase/frequency error, power vs time, ORFS, sensitivity and RX level of the two EGSM/DSC bands of the cellular phone. In the testing aspects described above, the aspects are tested or not independently. The results are stored in both text and graphic files for helping the RD engineers to discover the potential problems of the design and test the items that could be the problems.

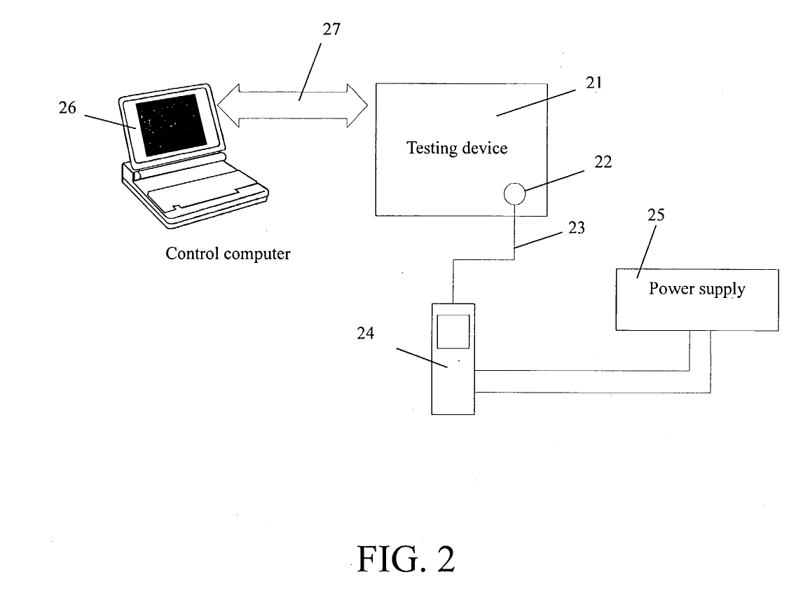

Please refer to FIG. 2. It is the schematic diagram for a cellular phone module test system to a preferred embodiment of the present invention, including a control computer 26, a test device 21 (Agilent 8960), a cellular phone module 24 for testing and a power supply 25. The control computer 26 has a graphic controlled program written in Labview programming language. The control computer 26 is connected to the test device 21 via a GPIB cable 27. The radio-frequency output/input point 22 of the test device 21 is connected to aerial point of the cellular phone module via a radio-frequency cable. The power supply 25 provides the power source for the cellular phone module 24. The steps of the present invention are as follows:

Firstly, the device 21 needs to be warmed up for at least 30 minutes before the graphic controlled software being executed. Make sure that the loss value of radio-frequency cable 23 in the testing frequency is known. The cellular phone module 24 is booted up and its signals are synchronized with the test device 21. And then, a test request is sent from the graphic controlled program to the test device 21. The test device 21 will execute the tests on that test module 24 after receiving the request and will send the test results back to the control computer 26 right after the tests finished.

The test request described above includes one selected from a group consisting of a TX power test, a phase peak error test, a phase root mean square (phase RMS) test, a frequency error test, a power vs time test, a modulating spectrum test, a switching spectrum test, a sensitive test, an input level sweep test and a frequency channel sweep test.

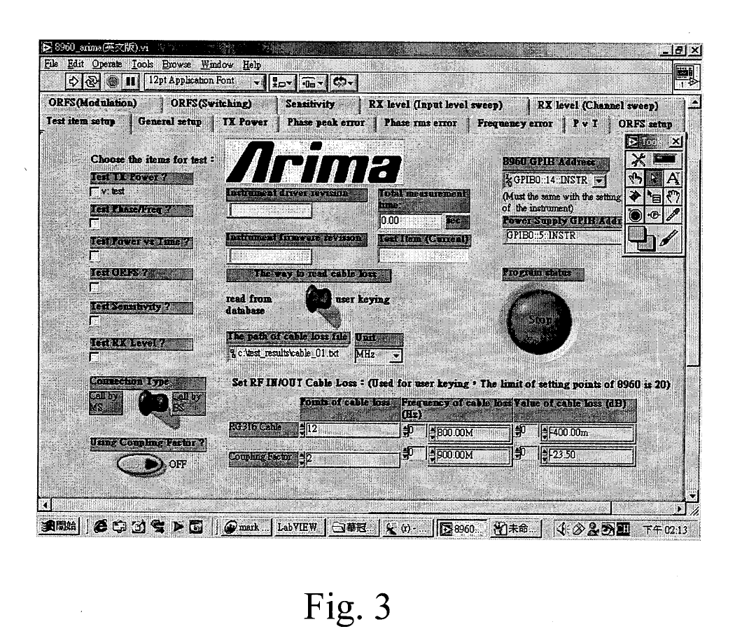

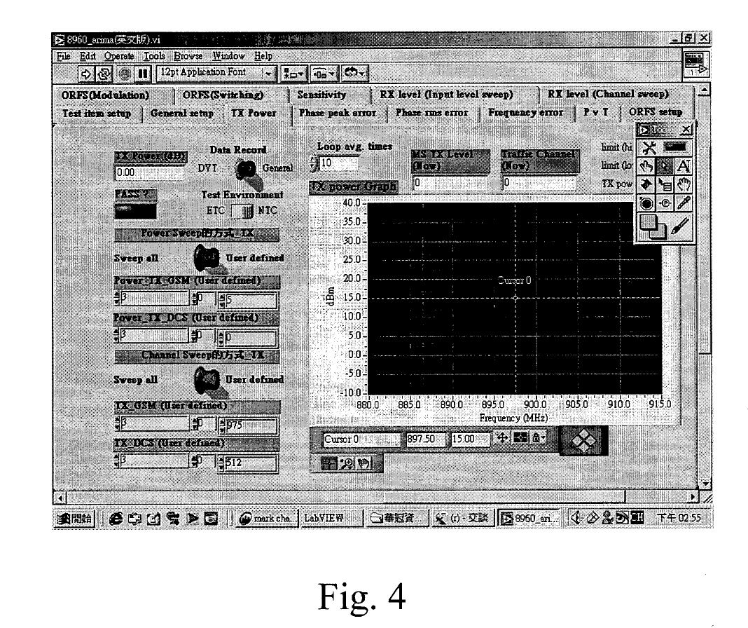

Please refer to FIG. 3. It is the initial displaying frame of the graphic controlled program to a preferred embodiment of the present invention. The program allows users to switch to different pages to check the related parameters' settings for the undergoing tests, the progresses for each test item (The results of some particular test items can be shown simultaneously.) and the display of the results after tests finished (FIG. 4 shows the select frame of the TX power test item). The functions and characteristics of this graphic controlled program are described as follows.

1. Each test item that you would like to measure can be independently selected. It also has the options to choose two ways for the connections. One is to dial from the cellular phone to the Agilent 8960 tester, the other is that the connection signals are sent from the station to the cellular phone.

2. The way of setting the Cable loss compensation values can be either from reading a file which stores all the compensation values (Also an automatic test program is designed to store all the Cable loss compensation values for each frequency to one file.) or through manually setting the Cable loss values for each frequency from the setting page by the users (An Agilent 8960 tester can have the compensation values for 20 different frequencies at most.).

3. Each parameter setting provided by the Agilent 8960 tester can be set independently.

4. There are two ways to set the power sweep and channel sweep. One is to set by users. The other way is to test all the power levels of European Telecommunication Standard Institute (ETSI) (EGSM 900: power level 5˜power level 19, DCS 1800: power level 0˜power level 15) and all the frequencies (EGSM 900: 975˜1023 & 124) automatically by program.

5. Each test item has the function for judging the results being pass or fail automatically for helping the users to determining the results being good or not. The judgement criterions on test items could be the European Telecommunication Standard Institute (ETSI) legislation or modified by the users.

6. The results can be stored in EXCEL file or any other text file for the transferring to the report file of the company. The graphs of the results will be stored in the path files (JPG file) set by the users.

7. The indicative light of program status will keep twinkling while the program is being executed. It will display an indicative frame for the user's judging the program executing status while the test is finished.

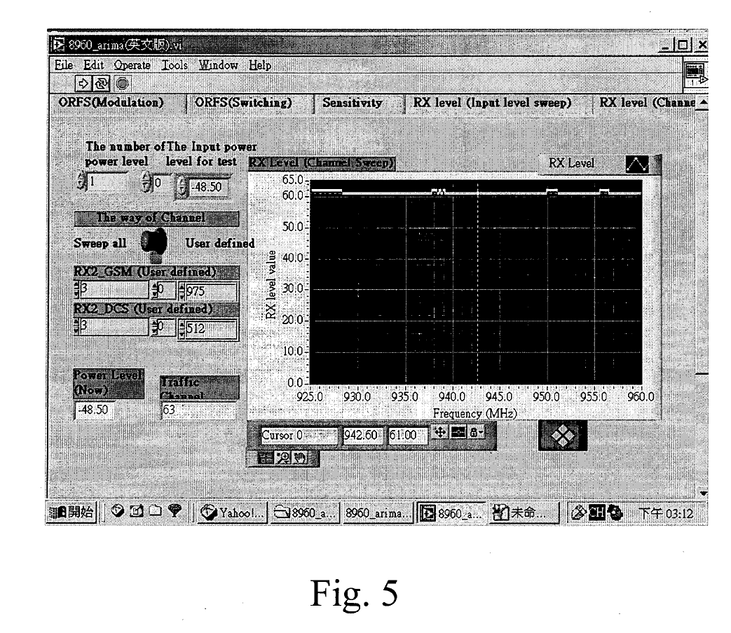

Please refer to FIG. 5. It is the test result of the test item RX level (channel sweep) for scanning the whole EGSM 900 frequency channels to a preferred embodiment of the present invention. It is an example for the cellular phone module 24 to be preceded the RX level (channel sweep) test for scanning the whole EGSM 900 frequency channels. It is the flatness of the RX level at a fixed input power level for each text frequency. This result can help RD engineers to realize whether the power compensation of firmware is correct or not. So RD engineers can do the best settings. It takes 2˜3 days to proceed the measure of EGSM 900 for the whole power levels and whole frequencies manually. But the measuring time can be shorten to a few hours via the automatic testing system.

It is the GPIB-USB-A serial of NI company for GPIB cable of the present invention. Because the automatic testing system is connected to the control computer via an USB interface. The advantages of an USB interface are easy to be inserted, easy to be pull out and to be carried conveniently. It is suitable to develop the automatic testing program for combing the devices described above, the Labview graphic controlled interface and the flow-chart programming language edit system. The followings are the operation descriptions for the graphic controlled program.

1. The preparations before the automatic testing system being executed.

1) Make sure that the Agilent 8960 testing device is correctly connected to the antenna connector of the cellular phone module 24 and the loss value of radio-frequency cable 23 at each testing frequency is known.

2) Make sure that the graphic controlled program 8960.exe has been stored in the controlled computer 26 and the controlled computer 26 has been connected to the Agilent 8960 testing device via a GPIB cable for normal connection (Make sure that all the connections are done normally via an application program “Measurement & Automation”.).

3) The preset key on the Agilent 8960 testing device is pressed for restarting the Agilent 8960 testing device.

4) The parameter of Cell Power for the Agilent 8960 testing device is set to −50.5 dBm. The parameter of Cell Band is set to the EGSM band value or DCS band value for testing.

5) The power source for the cellular phone module 24 is turned on. Make sure that the network settings of the Agilent 8960 testing device can be detected by the cellular phone module 24.

2. The operating methods are as follows:

1) The 8960_tx_rx.exe file is started via the mouse and then the preset displaying frame is displayed.

2) There are thirteen function tool bars includes Test item setup, General setup, TX Power, Phase peak error, Phase rms error, Frequency error, PvT, ORFS setup, ORFS1, ORFS2, Sensitivity, RX level (Input level sweep) and RX level (Channel sweep). Each function tool bar has its own displaying frame. The first two items include the parameters' settings before test. The other items provide the measure parameters of each test item and the test results for users' setting and observation (Because of the limitation of the displaying frame space, the parameter settings related to ORFS are separated into ORFS setup item). The setting and method for each function tool bar are introduced separately.

3) Test item setup:

(1) The items for testing are selected. (The blank grid before the item being marked indicates this item will be tested.).

(2) The connecting way between the Agilent 8960 testing device and the cellular phone module 24 is selected. (There are two ways for the connections. These two ways include ‘a call by BS’ or ‘a call by MS’. The former is that a call from the Agilent 8960 testing device is sent to the cellular phone module 24. The latter is that a call from the cellular phone module 24 is sent to the Agilent 8960 testing device.).

(3) The ‘Using Coupling Factor’ tool bar depends on whether the coupling factor is used by the cellular phone module 24. The preset status is off.

(4) The way to read in/out of cable loss compensation value: The way of setting the cable loss compensation values can be either from reading a file which stores all the compensation values or through manually setting the cable loss values for each frequency from the setting page by the users. The former way is that the path file, which stores the cable loss compensation values, is input. The filename and the pathway of the path file are input. Please refer to description (5) about the latter way.

(5) The loss compensation value of each test frequency is set by users via a ‘RF IN/OUT Cable Loss’ tool bar. The preset compensation value can be compensated back to the results automatically. There are two ways about the read-in/read-out of cable loss. One is the cable loss input by user. The other is the data file to be read in. The way to input by user is to set the numbers of compensation values (The Agilent 8960 testing device can have the compensation values for 20 different frequencies at most), the frequency (Hz) and the loss value (dB). The frequency means the serial number of matrix element. The loss value means the value of matrix element. For example, the cable loss values for two different frequencies are to be set. One is that the loss value is 1 dB for the frequency being 900 MHz. The other is that the loss value is 2 dB for the frequency being 1800 MHz. The setting method is that the number of compensation values is two. The ‘900.00 M’ is filled in the zero matrix and the ‘1800.00 M’ is filled in the first matrix for the settings of frequencies. The number of ‘−1.0’ is filled in the zero matrix and the number of ‘−2.0’ is filled in the first matrix for the settings of cable loss values. The setting method of data files read in/out is that the pathways of files stored the cable loss compensation values are input by user. Only one way can be selected.

PS 1: It has the corresponding relationship between the matrixes of ‘frequency of cable loss’ tool bar and ‘cable loss’ tool bar.

PS2: When the ‘Using Coupling Factor’ tool bar is set to be ‘ON’, the loss value of the coupling factor is used. When the ‘Using Coupling Factor’ tool bar is set to be ‘OFF’, the loss value of the RG316 cable is used

(6) The driver vision number and the firmware vision number of the Agilent 8960 testing device now are displayed via the ‘Instruction driver revision’ tool bar and the ‘Instrument firmware revision’ tool bar.

(7) The time of the test spending is displayed via the ‘total time for the test’ item. The unit of the total time for the test is second. The total time for the test will be displayed right after the test is finished.

(8) The input value of the GPIB Address must be the same as in the GPIB Address of the Agilent 8960 testing device. The file is input as follows.

GPIB0: the GPIB of Agilent 8960 test device

Address: INSTR

(9) The correct test SIM card number is correctly input by the user (The preset number is 001011234567890.) via the ‘IMSI Number’ tool bar.

4). ‘General setup’ tool bar: This tool bar provides the users to do the settings.

(1) Operation Mode: One of the active mode or test modes is chosen. When the test mode is chose, the cellular phone module 24 must be able to be promoted into test mode.

(2) Cell Band: One of the ‘EGSM band’ or the ‘DCS 1800 band’ is chose.

(3) Cell Power: The value of cell power for station is set by user. The unit of cell power is dBm.

(4) TCH timeslot: The time slot of traffic channel is set by user. The preset value is 4.

(5) Loop-back Mode: There are Type A, Type B and Type C for the loop-back modes of test signals according to the GSM legislation.

(6) Meas Count (measure count): The counts for measuring are set by user. The setting is valid only for Tx Power item, Phase/Freq error item and PvT item.

(7) Burst type: It is valid only for the operation mode is set to be test mode.

(8) The pathway and filename of the path file for recording the results are input by user.: The pathway and filename of the path file for recording the results need to be completely input by user. The test results can be viewed by user via the text file. (The pathway must be established before testing.)

(9) EGSM/DCS Broadcast Channel: The channel number of broadcast channel for EGSM band or DCS band is set by user. The value can't be repeated with the channel number for the testing frequency of the band.

5). When the TX power function is to be tested, the ways of a power sweep and a channel sweep need to be set via the ‘TX power’ tool bar. The TX power for all the power levels and all the channels under the set band (EGSM 900 or DCS 1800) can be chose ether to be automatically tested by the user via ‘General setup’ tool bar or the particular levels and channels for testing are input by user in the user-defined matrix. The loop count is the count to repeat the same test. And then the average of the power value is obtained. This average value is the number for deciding the test is pass/fail in this test.

6). When the phase/frequency error function is to be tested, all the values need to be set for the judgement of the results being pass or fail in the phase peak error, phase rms error and frequency error. The settings of power sweep and channel sweep in the ‘Phase peak error’ tool bar are also for both phase/frequency error test items.

7). When the power vs time function is to be tested, the test numbers and the time offset value need to be set via the ‘PvT’ tool bar. Also the way of display simultaneously or accumulatively is set via the ‘PvT’ tool bar. The results will be shown on the displaying frame right after the traffic channel test is finished for simultaneous display. The results will be shown on the displaying frame via an accumulative way after all the traffic channels of a MS Tx level are finished. Similarly, the power sweep and channel sweep can be set via the ‘PvT’ tool bar.

8). When the ORFS function is to be tested, the test counts and the test frequencies for modulation spectrum (ORFS1) and switching spectrum (ORFS2) are set via the ‘ORFS setup’ tool bar. The frequency offset related to each test is set via the ‘ORFS setup’ tool bar too. Similarly, the power sweep and channel sweep (The ORFS1 and ORFS2 are affected simultaneously.) can be set via the ‘ORFS’ tool bar.

9). When the sensitivity function is to be tested, the burst number (the bit number for test) for BER (bit-error-rate) test, the initial power of BER test (the initial cell power value for sensitivity test), BER test type (The BER type is selected by user. The BER types include residual type Ia, residual type Ib, residual type II, type Ia, type Ib, type II. ), sensitivity limit (The value for judging the results being pass or fail is according to the user-defined critical value.), test numbers (The BER test value of test module must be smaller than the set value of BER spec. and then the cell power will be tested. If not, the cell power will not be tested.) Because the sensitivity test is to be proceeded when the power level is the biggest one, only the channel sweep is to be set and the power sweep is not included.

10). When the RX level (input level sweep) function is to be tested, the way of channel sweep is set in the ‘RX (Input level sweep)’ tool bar. The numbers of input level for scanning and the related cell power values are set too. The input level sweep is the test way which a channel is fixed for scanning the input power level.

11). When the RX level (Channel sweep) function is to be tested, the way of channel sweep and the input power level value are set in the ‘RX level (Channel sweep)’ tool bar. The channel sweep is the test way which the cell power is fixed for scanning the test frequency.

12). After all the settings are done, the test will be executed when the white arrow beyond the ‘Edit Function’ is pressed. Firstly, the window for indicating the user to assure all the parameters being set correctly is shown. The cursor is moved to the item for testing. When the execution is selected, a test request is sent from the program. The connection between the Agilent 8960 testing device and the cellular phone module 24 is done. The test is to be executed. When the item ‘back to the setting frame’ is selected, the program will be stopped for the user's setting.

13). When the record file exists in the pathway already, indicative information is to be shown. The user can choose either to replace or cancel.

3. The ways for the use of the graph are as follows.

The graphic interface includes a main displaying frame, a cursor function list and a graphic control list.

1). A main displaying frame: The main displaying frame provides the display of the test result. The title of each test is displayed on the left top of the frame. The meaning of each graph on the displaying frame is displayed in the panel on the right top of the frame. When the properties of a graph are to be changed, the steps are as follows: the cursor is moved to the graph title in the panel, the left key of the mouse is pressed, and then the color, line type, line thickness etc. are selectable. The user can move the cursor to the scale on axis X or axis Y and press the left key for changing the range for displaying. When the right key of the mouse is pressed on the main frame, the user can select to copy the graph or adjust the scale range on axis X or axis Y etc.

2). The cursor function list: It provides the marker function for graph. The left three variables are a marker title, the axis X coordinate of a marker and the axis Y coordinate of a marker in order. Refer to the right three panels for marker controlling. When the cursor is moved to the middle panel, the left key of the mouse is pressed for changing the properties of the marker. When the cursor is moved to the key-shape panel, the left key of the mouse is pressed for setting the coincidental graph and the coincidental way with the marker. It is useful for the accumulative graphs. When some graph is found to exceed in critical value in the accumulative graphs (After multiple frequencies are scanned, the graphs are displayed in accumulative way.). In order to find out which test frequency does the graph belong to, the coincidental way of marker can be changed to ‘Lock to plot’ by user. The marker is moved to the graph exceeded in critical value. The locked graph will be marked with ‘v’ in front of the graph title in the key-shape panel. So the related frequency for testing is found out.

3). A graphic control list: The graphic control list provides the functions for graph control. The functions of the three control panels from left to right are as follows. (1) The cursor is moved to the marker after the item being executed via the mouse. The marker can be moved to each position of the line segment in the graph. (2) The graph can be zoomed in (There are three types.) or restored after the item being executed via the mouse. (3) The cursor will be changed to a palm-shape cursor after the item being executed via the mouse. The user can move the graph to any position in the main displaying frame via pressing the left key of the mouse and holding this action.

In conclusion, the present invention is to develop the graphic control program that combines the current test device and automatically tests TX/RX functions for the cellular phone products. And the test results can be displayed in GUI (Graphic User Interface) and also be stored in both text and graphic files. This will help the RD engineer to discover the potential problems of the design. And the automatic test environment definitely helps a lot on saving manpower, test time and discovering problems and greatly improves the disadvantages of prior arts. So the present invention has its value for this industry and that is the main reason why this present invention is.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A testing system for a cellular phone module, comprising:
a control computer having a graphic controlled program for providing a test request, wherein said graphic controlled program is written in Labview progra; and
a testing device electrically connected to said control computer and said cellular phone module for testing said cellular phone module in response to said testing request.

2. The testing system as claimed in claim 1, wherein said system comprises a power supply electrically connected to said cellular phone module for providing electricity.

3. The testing system as claimed in claim 1, wherein said testing device is a wireless communication tester.

4. The testing system as claimed in claim 1, wherein said testing device is electrically connected to said control computer via a GPIB cable.

5. The testing system as claimed in claim 1, wherein said testing device is electrically connected to said cellular phone module via a radio frequency cable.

6. The testing system as claimed in claim 1, wherein said control computer sends said test request to said testing device and then receives a testing result from said testing device, wherein said control computer further comprises a graphic interface for showing said testing results, wherein said testing result is stored in a text file and a graph file.

7. The testing system as claimed in claim 6, wherein said text file is an EXCEL file and said graph file is a JPG file.

8. The testing system as claimed in claim 6, wherein said graphic interface comprises a main displaying frame, a cursor function list and a graphic control list.

9. The testing system as claimed in claim 1, wherein said test request is one selected from a group consisting of a TX power test, a phase peak error test, a phase root mean square (phase RMS) test, a frequency error test, a power vs time test, an output radio frequency spectrum (ORFS) test, a sensitivity test and a RX level test.

10. The testing system as claimed in claim 9, wherein said output radio frequency spectrum (ORFS) test comprises a modulating spectrum test and a switching spectrum test.

11. The testing system as claimed in claim 9, wherein said RX level test comprises an input level sweep test and a frequency channel sweep test.

12. A method for testing a cellular phone module via a testing device and a control computer having a test request, comprising steps of:
(a) sending a test request from a control computer to said testing device;
(b) testing said cellular phone module in response to said test request via said testing device for obtaining a testing result;
(c) sending said testing result from said testing device to said graphic controlled program;
(d) displaying and saving said result via said graphic controlled program; and
(e) determining said cellular phone module is good or not via said result.

13. The testing system as claimed in claim 12, wherein said control computer comprises a graphic controlled program.

14. The testing system as claimed in claim 13, wherein said graphic controlled program is written in Labview program language.

15. The testing method claimed in claim 12, wherein said test request is one selected from a group consisting of a TX power test, phase peak error test, a phase root mean square (phase RMS) test, a frequency error test, a power vs time test, an output radio frequency spectrum (ORFS) test, a sensitivity test and a RX level test.

16. The testing method claimed in claim 15, wherein said output radio frequency spectrum (ORFS) test comprises a modulation frequency spectrum test and a switching frequency test.

17. The testing method as claimed in claim 15, wherein said RX level test comprises an input level sweep test and a channel sweep test.

18. The testing method as claimed in claim 12, wherein said testing device is a wireless communication tester.

19. The testing method as claimed in claim 12, wherein said graph interface comprises a main displaying frame, a cursor function list and a graph control list.

20. The testing method as claimed in claim 12, wherein said result is stored in a text file and a graph file.

21. The testing method as claimed in claim 20, wherein said text file is an EXCEL file and said graph file is a JPG file.
